(19) United States
(12) Patent Application Publication
(10) Pub. No.: US 2010/0039381 A1
(43) Pub. Date: Feb. 18, 2010

(54) ROTATABLE INPUT DEVICE

(75) Inventors: Michael Andrew Cretella, JR., Santa Clara, CA (US); David Thomas Amm, Sunnyvale, CA (US)

Correspondence Address: SCHWEGMAN, LUNDBERG & WOESSNER/APPLE, PO BOX 2938, MINNEAPOLIS, MN, 55402, US

(73) Assignee: Apple Inc., Cupertino, CA (US)

(21) Appl. No.: 12/190,269

(22) Filed: Aug. 12, 2008

(51) Int. Cl. G06F 3/033

(52) U.S. Cl. 345/158; 345/163

(57) ABSTRACT

In an example embodiment, a computer mouse is provided. This computer mouse includes a surface tracking sensor that detects movement of the computer mouse along the support surface. Additionally included are one or more orientation sensors that detect a movement of the computer mouse relative to a pivot point. The computer mouse also includes a controller that is configured to translate the movement along the support surface into a two-dimensional coordinate and to translate the movement relative to the pivot point into a magnitude of rotation.

### FIELD

The present disclosure relates generally to input devices for processing systems, and more particularly, relates to cursor-directing devices, such as a computer mouse that is rotatable relative to a support surface.

### BACKGROUND

As is well-known, a computer mouse is a hand-operated device typically used for navigating a cursor displayed on a computer screen for control of graphical user interfaces. The mouse functions by detecting translational, or two-dimensional motion along its support surface, and translating this motion into movement of the cursor. A conventional mouse usually includes at least one input or control button or an equivalent touch-sensitive location, but may commonly include multiple buttons or touch sensitive locations, and may include one or more scroll balls, and/or scroll wheels that provide additional input or control. It is believed that typical configuration of the mouse, although serviceable for input purposes, requires more complex motions, and therefore is a less intuitive experience for a user than is possible with other configurations and functionalities of the mouse.

Accordingly, embodiments of the invention provide new computer mice and methods for navigation with a mouse. These computer mice and navigation techniques offer particular advantages to navigate content displayed on a computer screen.

### SUMMARY

Example embodiments provide various computer mice and techniques for navigation with a computer mouse. In general, examples of the invention as described herein allow for additional movement of a mouse adapted to operate on a support surface. The examples are described herein primarily in the context of having a rotatable mouse situated on the support surface where a rotation of the mouse relative to a pivot point translates into a particular event.

As an example, such a mouse has a bottom surface with a convex shape. This convex shape allows the mouse to be rotatable on the support surface. This mouse includes a surface tracking sensor that detects translational movement of the mouse along the support surface. Additionally included are one or more orientation sensors that detect the rotational movement of the mouse.

A rotation of the mouse is used for moving content displayed on a processing system, such as a computer. As one example, a rotational movement of the mouse may translate into a scroll event that, when processed by the processing system, scrolls the displayed content. In another example, a rotational movement of the mouse may translate into a yaw event that, when processed by the processing system, rotates the displayed content.

### BRIEF DESCRIPTION OF DRAWINGS

The present disclosure is illustrated by way of example and not limitation in the figures of the accompanying drawings, in which like references indicate similar elements and in which:

FIG. 1 depicts a perspective view of an example computer mouse, in accordance with an example embodiment, that is adapted for operation on a support surface;

FIGS. 2A and 2B depict front and side sectional views of the mouse with an example bottom surface, in accordance with an example embodiment;

FIGS. 3A and 3B depict front and side sectional views of another example mouse with a different bottom surface, in accordance with another example embodiment;

FIG. 4 depict a schematic diagram of a machine in the example form of a rotatable computer mouse, in accordance with an example embodiment;

FIG. 5 depicts another side view of the computer mouse, in accordance with another example embodiment, for operation on a support surface;

FIG. 6 depicts a flow diagram of a general overview of a method, in accordance with an example embodiment, of processing input signals in a mouse;

FIG. 7 depicts a flow diagram of a general overview of another method, in accordance with another example embodiment, of processing input signals in a mouse;

FIG. 8 depicts a flow diagram of a general overview of a method, in accordance with an example embodiment, for moving displayed content with a rotatable mouse;

FIGS. 9A, 9B, and 9C depict diagrams of example navigation techniques based on rotational movement of the computer mouse, in accordance with various example embodiments; and

FIG. 10 depicts a simplified block diagram of a machine in the example form of a processing system within which a set of instructions, for causing the machine to perform any one or more of the methodologies discussed in FIGS. 8 and 9A-9C, may be executed.

### DETAILED DESCRIPTION

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

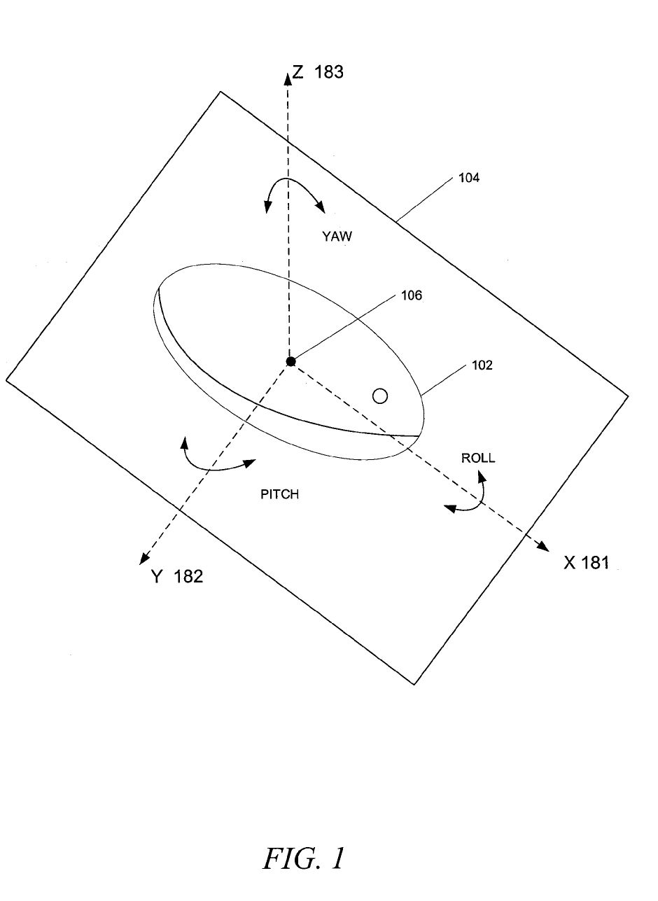

FIG. 1 depicts a perspective view of an example computer mouse 102, in accordance with an example embodiment, that is adapted to operate on a support surface 104. The mouse 102 rests upon the support surface 104 such that its bottom 102 contacts the support surface 104. As depicted in FIG. 1, the bottom surface of mouse 102 c has a convex shape, where a central portion is curved and protrudes outwardly relative to relatively peripheral portions of the bottom surface. For example, as explained and illustrated in more detail below, the mouse 102 may have a rounded bottom, having a continuous curve of either a uniform or varying radius. This rounded bottom contacts the support surface 104 at one or more pivot points, such as pivot point 106. A “pivot point” 106, as used herein, is a point at which the mouse 102 rotates.

The rounded bottom eases the mouse 102 to be moved relative to the pivot point 106 in the form of a rotational movement. As used herein, it should be noted that the concepts of “movement relative to a pivot point 106” and “rotational movement” may be used interchangeably. The mouse 102 may rotate around one or more axes, such as X longitudinal axis 181, Y lateral axis 182, and/or Z vertical axis 183 relative to pivot point 106. The X longitudinal axis 181 is an axis that passes through the mouse 192 from its front end to its back end. The following terminology is used herein, where a rotation of the mouse 102 around the X longitudinal axis 181 is a “roll.” The mouse 102 may also rotate around the Y lateral axis 182, which is an axis that passes from its left side to its right side. A rotation of the mouse 102 around the Y lateral axis 183 is a “pitch.” The Z vertical axis 183 is an axis that is perpendicular to both the X longitudinal axis 181 and the Y lateral axis 182. Rotation of the mouse 102 around the Z vertical axis 183 is a “yaw.”

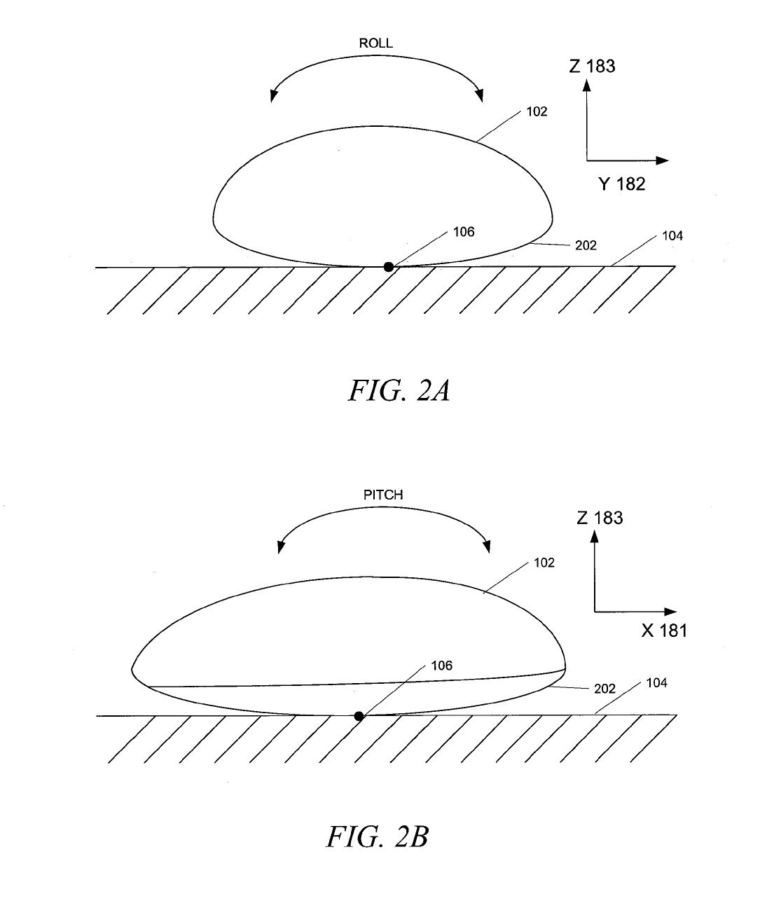

The bottom surface of the mouse 102 may have a variety of different convex shapes. FIGS. 2A and 2B depict front and side sectional views of the mouse 102 with an example bottom surface 202, in accordance with an example embodiment. FIG. 2A depicts a front sectional view of the mouse 102 resting on the support surface 104. With reference to the coordinate system of FIG. 1, the section view is a view along the X longitudinal axis 181, which is perpendicular to the Y-Z plane. In the example embodiment of FIG. 2A, the bottom surface 202 of the mouse 102 has a rounded shape in the form of a half oval. As a result of this rounded bottom, the mouse 102 can “roll” relative to the support surface 104 or relative to the pivot point 106. It should be appreciated that such a pivot point 106 may actually be a series of points, such as when the bottom surface 202 exhibits a similar contour to that depicted along all or a portion of the X longitudinal axis 181.

FIG. 2B depicts a side sectional view of the mouse 102 resting on the support surface 104. With reference to the coordinate system of FIG. 1, the side view is a view along the Y lateral axis 182, which is perpendicular to the X-Z plane. In the example embodiment of FIG. 2B, the bottom surface 202 of the mouse 102 has a rounded shape, which may also be in the form of a half oval. As a result of this rounded bottom, the mouse 102 can “pitch” relative to the support surface 104 or relative to the pivot point 106.

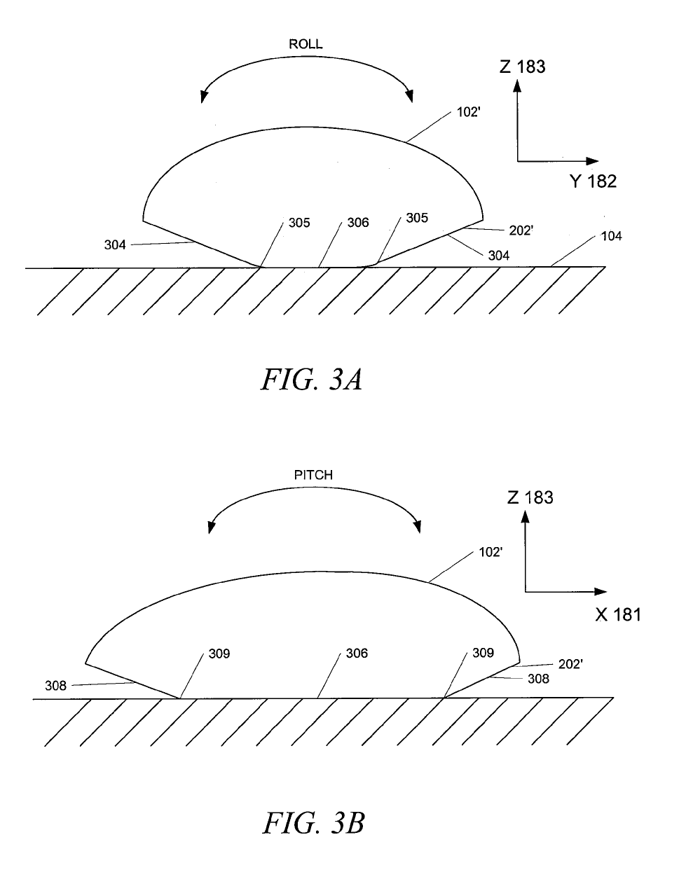

FIGS. 3A and 3B depict front and side sectional views of another example mouse 102′ with a different bottom surface 202′, in accordance with another example embodiment. FIG. 3A depicts the same front sectional view of an alternative configuration for the mouse 102′ with a bottom surface 202′ having a contour defined, in part, by angular sides 304 extending downwardly to a central contact section 306. The edges 305 formed between the contact surface 306 and the angular sides 304 can be rounded. Such rounding can be to any suitable degree needed to achieve a desired balance between stability of the mouse 102′ in an upright orientation, and ease of rolling of the mouse 102′.

FIG. 3B depicts a side sectional view of the mouse 102′ with the bottom surface 202′ also having a contour defined, in part, by angular sides 308 extending downwardly to the central contact section 306. The edges 309 formed between the contact surface 306 and the angular sides 308 can also be rounded. Such rounding can be to any suitable degree needed to achieve a desired balance between stability of the mouse 102′ in an upright orientation, and ease of rolling the mouse 102′.

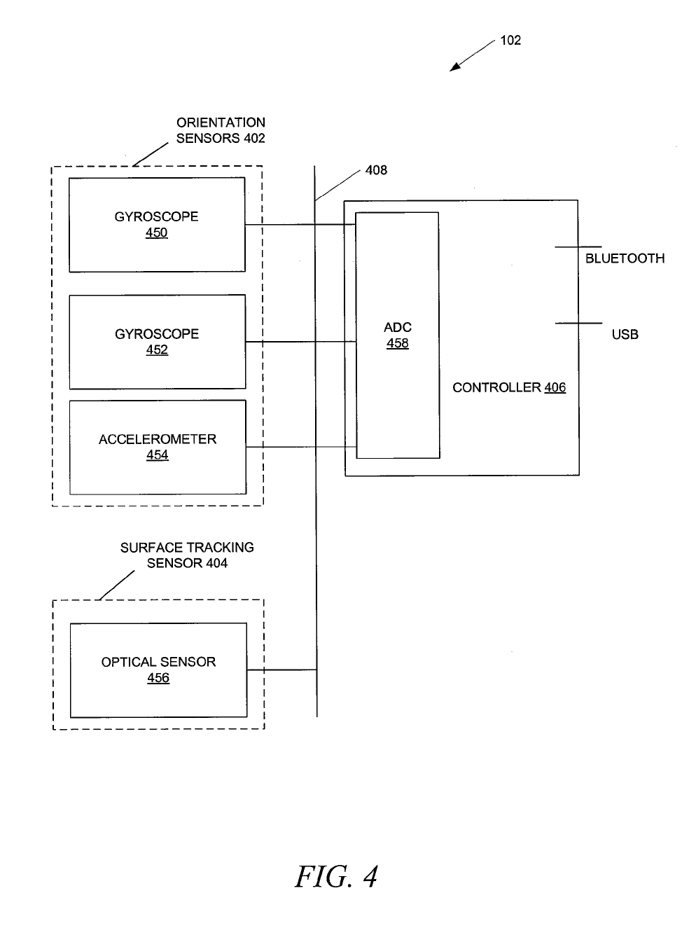

FIG. 4 depicts a schematic diagram of a machine in the example form of a rotatable mouse 102, in accordance with an example embodiment. The mouse 102 includes orientation sensors 402, surface tracking sensor 404, and controller 406, which may communicate with each other via bus 408. It should be appreciated that in addition to connection via bus 408 (e.g., Serial Peripheral Interface bus), the orientation sensors 402 and the surface tracking sensor 404 may also be directly connected to the controller 406.

The surface tracking sensor 404 is configured to detect movement of the mouse 102 along a support surface. An example of such a surface tracking sensor 404 is an optical sensor 456. The optical sensor 456 detects features of the support surface by, for example, taking images of the support surface. The optical sensor 456 includes a light source, such as a light-emitting diode (LED) or a laser diode, that illuminates the support surface. As explained in more detail below, movement of the mouse 102 along the support surface may be derived from the detected features. Another example of a surface tracking sensor 404 is a trackball mechanism. The trackball mechanism includes a ball retained within a casing such that the ball can rotate in any direction, in response to movement of the mouse 102 along the support surface. Two rollers included within the ball mechanism roll against the ball to generate electrical signals from which two-dimensional coordinates may be derived.

An orientation sensor, such as one of the orientation sensors 402 depicted in FIG. 4, is configured to detect a rotational movement of the mouse 102 relative to one or more pivot points. That is, the orientation sensor 402 is configured to detect the roll, pitch, and/or yaw of the mouse 102. A variety of orientation sensors may be used to detect such rotational movements. An example of an orientation sensor 402 is a gyroscope 450 or 452 used for measuring orientation or rotation based on detection of angular momentum. An example of a gyroscope 450 or 452 is a vibrating structure gyroscope embodied in a micro electro-mechanical systems (MEMS) device. Another example of a gyroscope 450 or 452 is a rotating gyroscope used to detect relative angular displacements and angular rates, which may be translated into a rotation of the mouse 102.

In the embodiment depicted in FIG. 4, the mouse 102 includes two gyroscopes 450 and 452. Each gyroscope 450 or 452 is a single-axis gyroscope that is configured to detect rotation around one axis (e.g., X longitudinal axis, Y lateral axis or Z vertical axis). For example, gyroscope 450 is configured to detect a roll of the mouse 102. On the other hand, gyroscope 452 is configured to detect a pitch of the mouse 102. The mouse 102 may also include a third, single-axis gyroscope (not shown) that detects a yaw of the mouse 102. It should be appreciated that the gyroscope 450 or 452 may also be a dual axes or a three axes gyroscope that is configured to detect and measure rotation around dual axes or around all three axes, respectively. Accordingly, in another example embodiment, gyroscopes 450 and 452 may be replaced with a single, dual-axis gyroscope that is configured to detect both the roll and yaw of the mouse 102.

Another example of such an orientation sensor 402 is an accelerometer 454 used for measuring acceleration. For example, the accelerometer 454 can measure the acceleration resulting from a rotation of the mouse 102 and, as explained in more detail below, also the direction of gravity. The velocity and rotational position (or orientation) of the mouse 102 may be derived from the measured acceleration. It should be appreciated that the accelerometer 454 may include, for example, a piezoelectric accelerometer, a piccolo accelerometer, a magnetic induction accelerometer or a laser accelerometer in the form of MEMS device. The accelerometer 454 may be configured to measure acceleration along one axis (e.g., X longitudinal axis, Y lateral axis or Z vertical axis), along dual axes, or along all three axes.

However, in the example embodiment depicted in FIG. 4, the accelerometer 454 is not used to detect a rotation of the mouse 102. Instead, the accelerometer 454 is used for calibrating the gyroscopes 450 and 452. It should be appreciated that the mouse 102 may be resting on a slightly slanted support surface, such as a slightly slanted desk. From the viewpoint of a user, the mouse 102 resting on the desk has not been rotated and is lying perfectly balanced. However, the gyroscopes 450 and 452 may detect a roll and/or a pitch of the mouse 102 on such a slanted support surface, which results in the transmission of unintended or false movements to a computer in communication with the mouse 102.

To correct for the uneven support surface, the accelerometer 454 can be used to detect the direction of gravity, which can be expressed as a vector. As a result, when the gyroscopes 450 and 452 are calibrated, the accelerometer 454 can detect that the mouse 102 is slightly rotated. The gyroscopes 450 and 452 may therefore be calibrated in reference to the direction of gravity. For example, a gravity vector may be detected by the accelerometer 454 during calibration of the gyroscopes 450 and 452. After calibration, the controller 406 may subtract the gravity vector from or add the gravity vector to angular displacements detected by the gyroscopes 450 and 452 in order to compensate for the slight rotation detected by the accelerometer 454.

It should be appreciated that the calibration of the mouse 102 may be manually or automatically triggered. To calibrate the mouse 102, the mouse 102 needs to be stationary. This stationary position of the mouse 102 is used as a reference point to calculate or identify relative movement. In automatic calibration, the mouse 102 can detect that it is stationary by referencing the accelerometer 454. In this example embodiment, the accelerometer 454 can be configured to also detect acceleration along a direction parallel to the support surface. That is, the accelerometer 454 can detect acceleration of the mouse 102 along the support surface. The controller 406 may be configured to calibrate the gyroscopes 450 and 452 in reference to this detected acceleration along the support surface. As an example, if the accelerometer 454 does not detect acceleration along the support surface, then the mouse 102 is most likely to be in a stationary state. There is a possibility that the mouse 102 may be moving at a constant rate or velocity, but such movement is rare. Alternatively, the mouse 102 can also detect that it is stationary by referencing the surface tracking sensor 404. If the surface tracking sensor 404 does not detect movement of the mouse 102 along a support surface, then the mouse 102 is in a stationary state. As a result, in automatic calibration, the controller 406 may automatically calibrate the gyroscopes 450 and 452 when the accelerometer 454 does not detect acceleration along the support surface or when the surface tracking sensor 404 does not detect movement along the support surface.

The accelerometer 454 may also be used in manual calibration of the gyroscopes 450 and 452. For example, a user may manually instruct the mouse 102 to calibrate itself. With the receipt of the calibration request, the controller 406 analyzes the signals from the accelerometer 454 to identify whether the accelerometer 454 detects movement of the mouse 102 along the support surface. If the accelerometer 454 does not detect acceleration, then the controller 406 initiates a calibration operation of the gyroscopes 450 and 452. On the other hand, if the accelerometer 454 detects acceleration along the support surface, then the mouse 102 is not stationary and therefore, the controller 406 overrides the instructions from the user and does not initiate a calibration operation.

It should be appreciated the accelerometer 454 may also detect movement of the mouse 102 along the support surface. Such movement may be calculated by integrating the acceleration of the mouse 102. However, in this example embodiment, the accelerometer 454 is not used to detect such movement along the support surface because the optical sensor 456 is generally more accurate in detecting such movements.

The controller 406 is a circuit configured to process electrical signals from the orientation sensors 402 and surface tracking sensor 404. An example of the controller 406 includes a microprocessor within which a set of instructions, for causing the machine to process the electrical signals, may be executed. Another example of the controller 406 is an application-specific integrated circuit (ASIC). The controller 406 is configured to process input signals from the surface tracking sensor 404 and the orientation sensors 402, which may include translating the input signals from the surface tracking sensor 404 into two-dimensional coordinates. A two-dimensional coordinate defines a position of the mouse 102 along the support surface. The two-dimensional coordinate includes at least one value that defines a position of the mouse 102 along the X longitudinal axis and at least one other value that defines the position along the Y lateral axis. The values may define the position of the mouse 102 relative to the last known position or relative to a pre-defined reference point. The range of values depends on the accuracy or resolution of the surface tracking sensor 456. For example, a value that defines a position of the mouse 102 along the X longitudinal axis may range from −128 to +127, where a negative value defines a left direction while a positive value defines a right direction. Surface tracking sensor 456 with higher accuracies result in a larger range of values available for the two-dimensional coordinate. It should be appreciated that the translation of input signals into a two-dimensional coordinate may include a variety of well-known processing techniques, such as filtering and integrating the input signals from the surface tracking sensor 456.

Processing may also include the translation of input signals from the orientation sensors 402 into magnitudes of rotation. A “magnitude of rotation,” as used herein, refers to an amount of rotational movement of the mouse 102 that may be expressed as degrees, a one byte value having 256 levels of resolution or other values. As an example, the magnitude of rotation that defines a rotation of the mouse 102 may also range from −128 to +127, where a negative value defines a clockwise rotation while a positive value defines a counterclockwise rotation. The range of values also depends on the resolution of the surface tracking sensor 456. It should also be appreciated that the translation of input signals into magnitudes of rotation may include a variety of well-known processing techniques, such as filtering and integrating the input signals from the orientation sensors 402.

Still referring to FIG. 4, the controller 406 may also include an analog to digital converter (ADC) 458 for converting analog signals from analog devices, such as gyroscopes 450 and 452 and accelerometer 454, into digital signals. It should be appreciated that the gyroscopes 450 and 452 and the accelerometer 454 may also be digital, and the electrical signals from such digital devices are not processed through the ADC 458. The controller 406 may directly transmit the events in the form of a control signal to a computer by way of wireless communication (e.g., Bluetooth) or direct connection (e.g., Universal Serial Bus). It should be appreciated that the control signal transmitted by the mouse 102 may include a variety of information items. In an example, the controller 406 may transmit a control signal with the two-dimensional coordinates, information identifying the rotational movement (e.g., roll, pitch or yaw), and the magnitude of rotation, directly to the computer. Alternatively, the controller 406 may further process the two-dimensional coordinates and magnitude of rotation into events, which is explained in more detail below, and transmit such events in the form of a control signal to the computer.

It should be noted that, in another example embodiment, the mouse 102 may not include the controller 406 for processing the input signals from the orientation sensors 402 and the surface tracking sensor 404. Instead, the input signals are directly transmitted to a processing system (not shown) having another controller (e.g., central processing unit (CPU)) that can process the input signals.

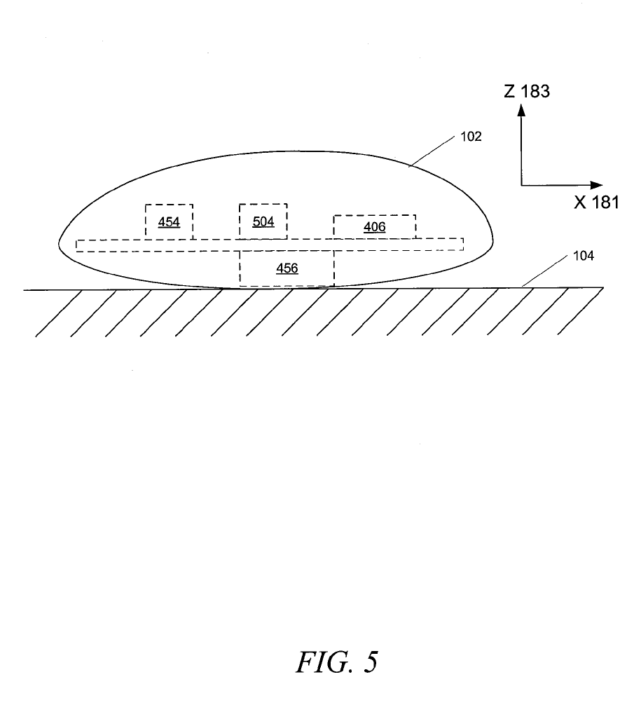

FIG. 5 depicts another side view of the mouse 102, in accordance with another example embodiment, for operation on a support surface 104. With reference to the coordinate system of FIG. 1, this side view is a view along the X-Z plane. As depicted in FIG. 5, the mouse 102 includes a gyroscope 504, an accelerometer 454, an optical sensor 456, and a controller 406, which may communicate with each other via bus. In this example, the gyroscope 504 is a triple-axes gyroscope that detects the roll, pitch, and yaw of the mouse 102. The accelerometer 454 is used to detect the acceleration of gravity for use in calibration of the gyroscope 504.

As discussed above, the optical sensor 456 detects features of the support surface 104 by, for example, taking images of the support surface 104. In addition to identifying a movement of the mouse 102 along the support surface 104 based on the features, the controller 406 can also calibrate the gyroscope 504 in reference to such features. As discussed above, the mouse 102 needs to be stationary during calibration of the gyroscope 504. In an example embodiment, the mouse 102 can detect that it is stationary by referencing the features of the support surface 104. Here, the controller 406 can be configured to identify a quality of the support surface 104 (or SQUAL) from the features. The controller 406 may calculate a value that defines the quality. For example, the quality of the support surface may be a number of features that are found in the image captured by the optical sensor 456. A high quality means that features of the support surface 104 are highly identifiable. On the other hand, a low quality means that features of the support surface 104 are not easily identified. The quality of the support surface is dependent on a variety of factors, such as the type of support surface 104, color of the support surface 104, and distance of the mouse 102 from the support surface 104.

The mouse 102 may check the quality of the support surface 104 while in calibration mode. As an example, if the quality exceeds a particular threshold, then the gyroscope 504 can be calibrated. On the other hand, if the quality falls below this particular threshold, then the gyroscope 504 cannot be calibrated. For example, if the mouse 102 is lifted from the support surface 104, then the quality may be low because features of the support surface 104 cannot be detected at a far distance. A low quality may therefore identify that the mouse 102 is lifted and not stationary. The gyroscope 504 may not be calibrated when the quality of the support surface 104 is low or falls below a particular threshold. If the mouse 102 is resting on or in contact with the support surface 104, then the quality may be high because features of the support surface 104 are more easily detectable at a close distance. To be stationary, the mouse 104 needs to be resting on the support surface 104. The gyroscope may therefore be calibrated when the quality of the support surface 104 is high or exceeds this particular threshold. By examining the acceleration along the support surface 104 detected by the accelerometer 454, as discussed above, and examining the quality of the support surface 104, the controller 406 can more accurately identify that the mouse 102 is stationary in order to initiate a calibration operation.

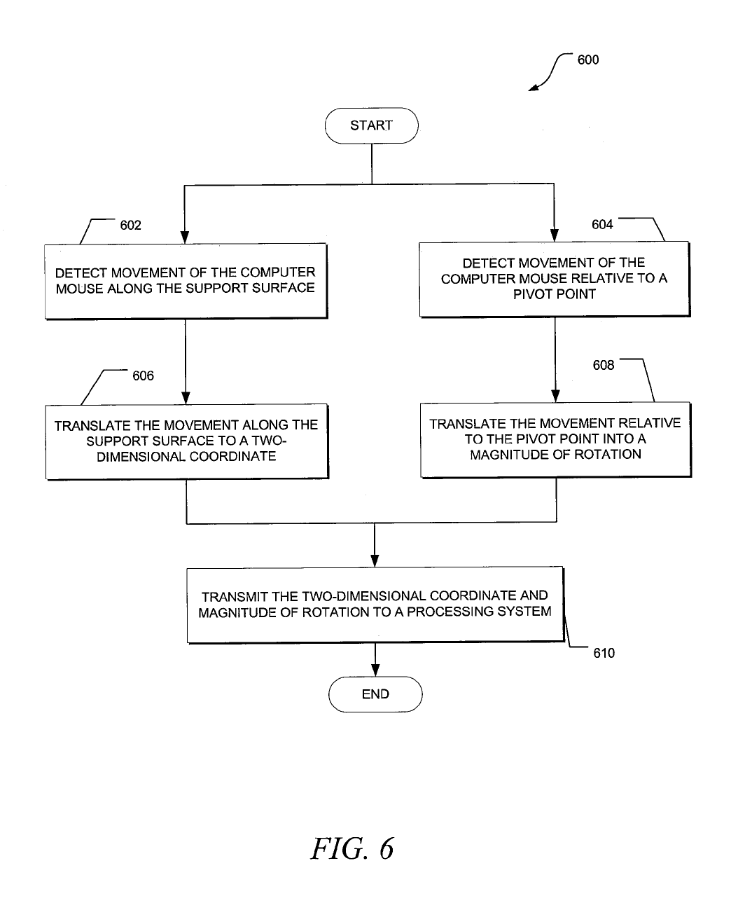

FIG. 6 depicts a flow diagram of a general overview of a method 600, in accordance with an example embodiment, of processing input signals in a mouse. In an example embodiment, method 600 may be employed by the computer mouse 102 depicted in FIG. 4. As depicted in FIG. 6, a surface tracking sensor detects movement of the mouse along the support surface at 602. The detected movement along the support surface is translated into a two-dimensional coordinate at 606, which is discussed above, and transmitted to a processing system at 610 in the form of a control signal.

At the same time, one or more orientation sensors detect movement relative to a pivot point at 604. Such a rotational movement is then translated into a magnitude of rotation at 608, which is discussed above. The magnitude of rotation is then transmitted in the form of a control signal to a processing system at 610.

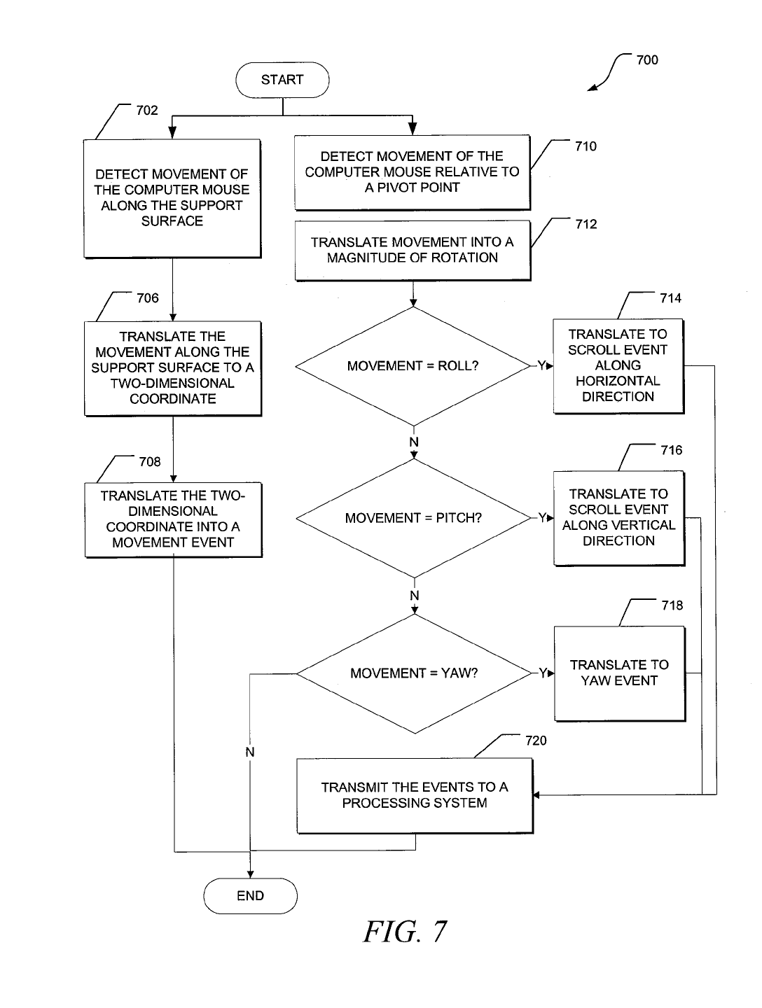

FIG. 7 depicts a flow diagram of a general overview of another method 700, in accordance with another example embodiment, of processing input signals in a mouse. In an example embodiment, method 700 may be employed by the mouse 102 depicted in FIG. 4. As depicted in FIG. 7, a surface tracking sensor detects movement of the mouse along the support surface at 702. The detected movement along the support surface is translated into a two-dimensional coordinate at 706, which is discussed above, and the two-dimensional coordinate may then be translated into a movement event at 708. An “event,” as used herein, refers to a value that maps to a particular command. For example, an event may be a packet defined by a Universal Serial Bus (USB) Human Interface Device (HID) protocol that includes an HID header and a value. The value identifies a property of the command and the HID header includes information that identifies the type of command. It should be noted that events may be mapped to a variety of commands, such as move up, move down, move right, move left, scroll left, scroll right, scroll up, scroll down, clockwise rotation, counterclockwise rotation, and other commands.

In the context of translating the two-dimensional coordinate into a movement event, for example, the movement event includes move up, move down, move right or move left. It should be appreciated that the translation process may include a variety of operations on the two-dimensional coordinate, such as filtering the two-dimensional coordinate, calculating an average of a series of two-dimensional coordinates, integrating the two-dimensional coordinate, and other operations. In an example, a one bit value assigned to a movement event may identify the occurrence of a movement event. For example, when the mouse is moved to the right, the two dimensional coordinate may be translated into a one bit value, and this one bit value is transmitted in a packet, along with an HID header that identifies the one bit value to correspond with a move right command, to a processing system in communication with the mouse at 720. The processing system receives the packet, maps the packet to a move right command, and may then move a cursor or a displayed content to the right in pre-defined increments. It should be noted that the displayed content can include any suitable content rendered by a computer or processing system. Examples of displayed content include graphical user interface (GUI), images, documents, and videos.

The frequency of transmission of the movement event may correspond to a velocity and/or acceleration of the mouse. For example, a large number of movement events may be transmitted to the processing system within a time period when the mouse is moving at a high velocity. Conversely, a low number of movement events may be transmitted to the processing system within the same time period when the mouse is moving at a low velocity.

At the same time, one or more orientation sensors are detecting movement of the mouse relative to a pivot point at 710. Such a rotational movement is then translated into a magnitude of rotation at 712, which is discussed above. Instead of directly transmitting this magnitude of rotation to the processing system, the magnitude of rotation may be further translated into a scroll event or a yaw event. A scroll event is an input that maps to a command that, when processed by a processing system, translates the input into a scroll of displayed content along a horizontal direction or a vertical direction. As depicted in FIG. 7, if the rotational movement is a roll, then the magnitude of rotation is translated to a scroll event along a horizontal direction at 714. The direction of the horizontal scroll (e.g., left scroll or right scroll) corresponds to the direction of the roll (e.g., clockwise rotation or counterclockwise rotation around X longitudinal axis). On the other hand, if the rotational movement is a pitch, then the magnitude of rotation is translated to a scroll event along a vertical direction at 716. Similarly, the direction of the vertical scroll (e.g., scroll up or scroll down) corresponds to the direction of the pitch (e.g., clockwise rotation or counterclockwise rotation around Y lateral axis). If the rotational movement is a yaw, then the magnitude of rotation is translated to a yaw event at 718 which, as described in more detail below, is an input that maps to a command that rotates displayed content. The direction of the rotation command (e.g., clockwise rotation or counterclockwise rotation) corresponds to the direction of the yaw (e.g., clockwise rotation or counterclockwise rotation around Z vertical axis). In both a scroll event, and a yaw event, the described mapping may be performed either within the mouse itself, or within the attached processing system, such as through appropriately configured drivers.

It should be appreciated that translation of the magnitude of rotation into events may also include a variety of operations such as, for example, comparing the magnitude of rotation to a pre-defined threshold value. If the magnitude of rotation exceeds this threshold value, then a scroll event or a yaw event is generated. A one bit value, for example, may also represent the occurrence of a scroll event or a yaw event. As an example, when the mouse is rolled in a clockwise direction, the magnitude of rotation may be translated into a one bit value and this one bit value is transmitted in a packet, along with an HID header that identifies the one bit value to correspond with a scroll right command, to a processing system in communication with the mouse at 720. The processing system that receives the packet and may then scroll displayed content to the right in pre-defined increments, which is described in more detail below. The frequency of transmission of the scroll event or yaw event may correspond to the rate of rotation of the mouse. For example, a large number of movement events may be transmitted to the processing system within a time period when the mouse is rotated as a quick rate. On the other hand, a low number of movement events may be transmitted to the processing system within the same time period when the mouse is rotated at a low rate.

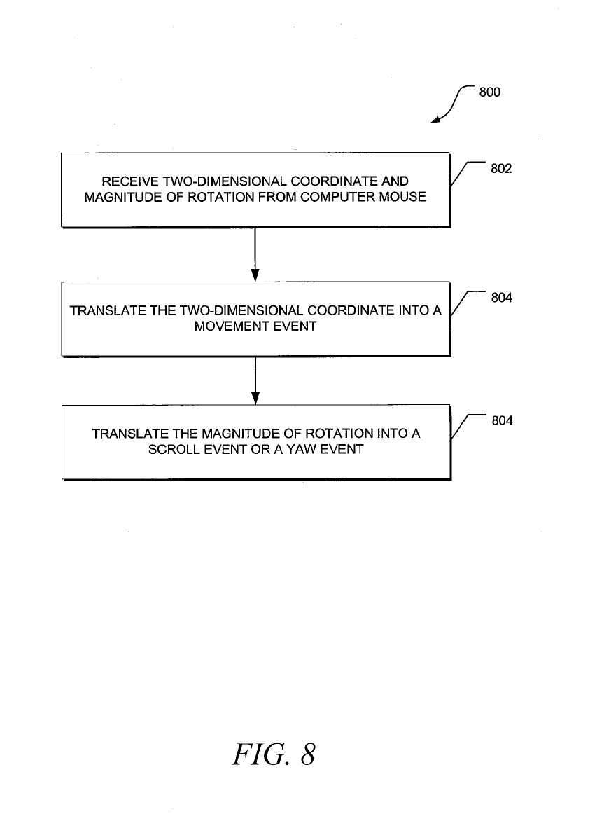

FIG. 8 depicts a flow diagram of a general overview of a method 800, in accordance with an example embodiment, for moving displayed content with a rotatable mouse. In an example embodiment, method 800 may be employed by a computer or other processing system, which is described in more detail below. As depicted in FIG. 8, a control signal from the mouse is received at 802. In an example embodiment, this control signal may include a two-dimensional coordinate, an identifier that identifies the rotational movement, and a magnitude of rotation associated with the rotational movement. The processing system that receives the control signal may directly forward the two-dimensional coordinate and the magnitude of rotation to an application, where such values may be directly used in, for example, the control of displayed content in videogames.

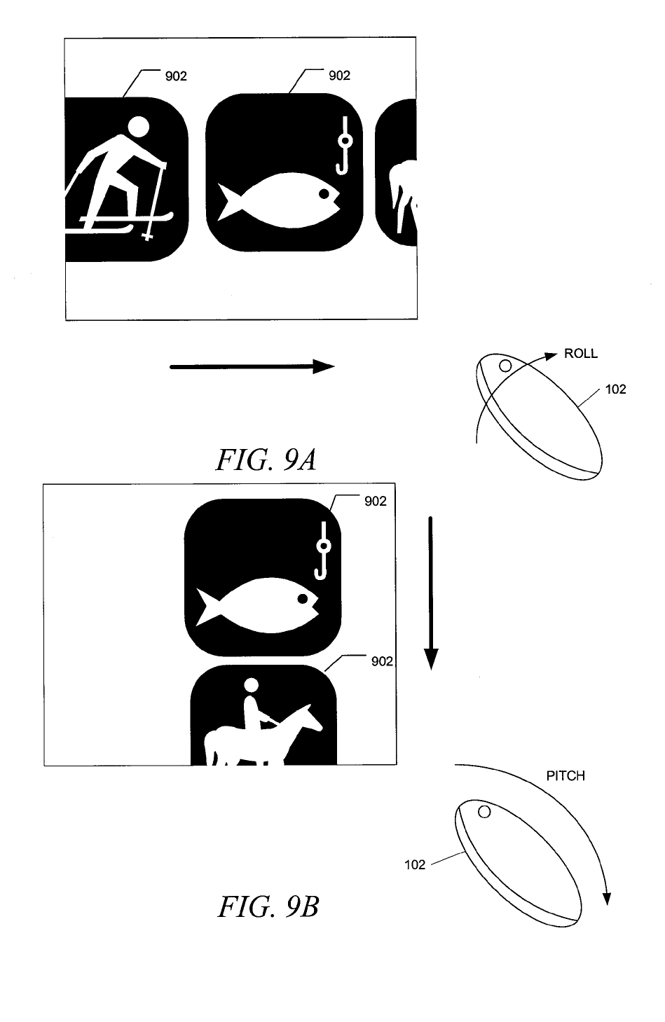

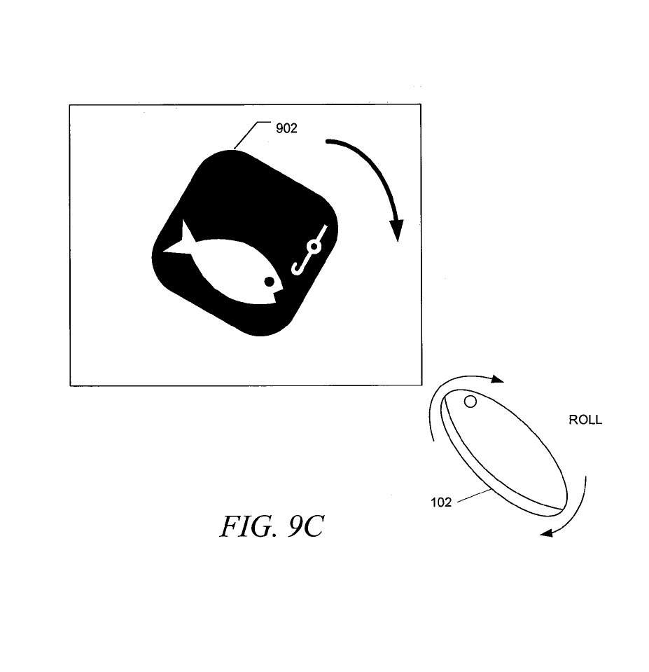

In an alternate example embodiment, the processing system may further translate the two-dimensional coordinate into a movement event at 804 and translate the magnitude of rotation into either a scroll event or a yaw event at 806, the translation processes being described above. In effect, instead of the mouse doing the translation processing, the processing system is configured to process the two-dimensional coordinate and magnitude of rotation into events, which may be used by the processing system to move displayed content. FIGS. 9A-9C depict diagrams of example navigation techniques based on rotational movement of the mouse 102. The processing system may use the two-dimensional coordinate, the magnitude of rotation, or events to move displayed contents. For example, as depicted in FIG. 9A, a clockwise roll of the mouse 102 results in a control signal sent to the processing system that identifies a clockwise roll and a magnitude of the clockwise roll. In turn, the processing system translates the clockwise roll into a scroll right event that, when processed by the processing system, scrolls or pans the displayed content 902 along the right direction in predefined increments. The speed of the scroll can be based on the magnitude of the roll. For example, a large magnitude may result in a high scroll speed while a small magnitude may result in a low scroll speed.

In the diagram depicted in FIG. 9B, a pitch of the mouse 102 towards a user results in a control signal sent to the processing system that identifies a clockwise pitch and a magnitude of the clockwise pitch. In turn, the processing system translates the clockwise pitch into a scroll down event, when processed by the processing system, that scrolls the displayed content 902 along the down direction in predefined increments. Again, the speed of the scroll can be based on the magnitude of the pitch.

In the example of FIG. 9C, a clockwise yaw of the mouse 102 results in a control signal sent to the processing system that identifies a clockwise yaw and a magnitude of the clockwise yaw. In turn, the processing system translates the clockwise yaw into a yaw clockwise event that, when processed by the processing system, rotates the displayed content 902 in a clockwise direction. The amount or degree of rotation is based on the magnitude of the yaw.

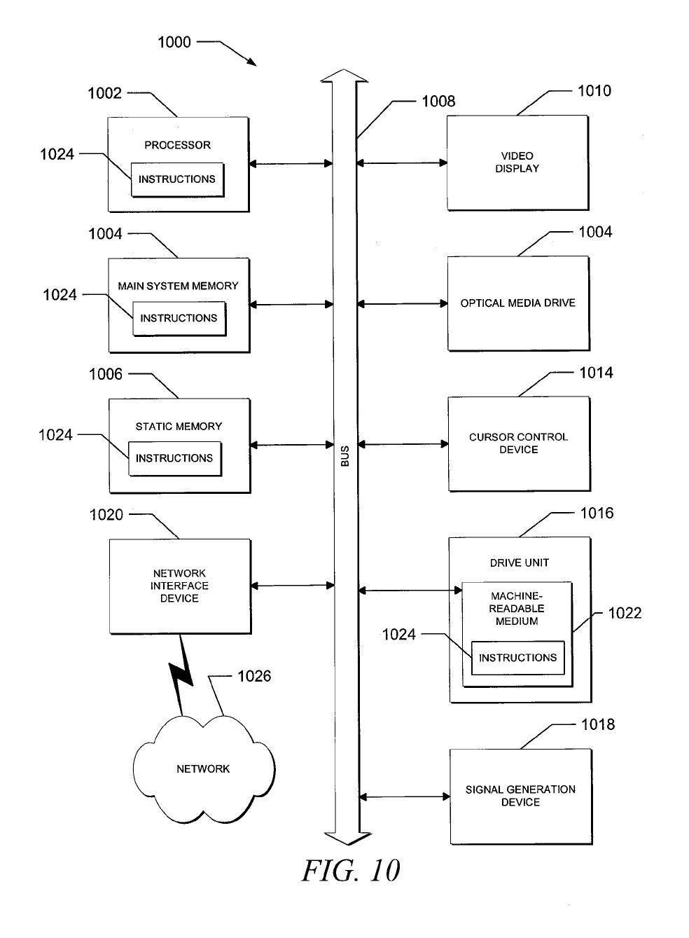

FIG. 10 depicts a simplified block diagram of a machine in the example form of a processing system within which a set of instructions, for causing the machine to perform any one or more of the methodologies discussed in FIGS. 8 and 9A-9C, may be executed. In alternative embodiments, the machine may be connected (e.g., networked) to other machines. In a networked deployment, the machine may operate in the capacity of a server or a client machine in client-server network environment, or as a peer machine in a peer-to-peer (or distributed) network environment. While only a single machine is illustrated, the term “machine” shall also be taken to include any collection of machines that individually or jointly execute a set (or multiple sets) of instructions to perform any one or more of the methodologies discussed herein.

Example processing system 1000 includes processor 1002 (e.g., a central processing unit (CPU), a graphics processing unit (GPU) or both), main system memory 1004 and static memory 1006, which communicate with each other via bus 1008. The processing system 1000 may further include video display unit 1010 (e.g., a plasma display, a liquid crystal display (LCD) or a cathode ray tube (CRT)). The processing system 1000 also includes optical media drive 1004, user interface (UI) navigation device 1014 (e.g., a mouse), disk drive unit 1016, signal generation device 1018 (e.g., a speaker) and network interface device 1020.

The disk drive unit 1016 includes machine-readable medium 1022 on which is stored one or more sets of instructions and data structures (e.g., software 1024) embodying or utilized by any one or more of the methodologies or functions described herein. Software 1024 may also reside, completely or at least partially, within main system memory 1004 and/or within processor 1002 during execution thereof by processing system 1000, with main system memory 1004 and processor 1002 also constituting machine-readable, tangible media. Software 1024 may further be transmitted or received over network 1026 via network interface device 1020 utilizing any one of a number of well-known transfer protocols (e.g., Hypertext Transfer Protocol (HTTP)).

While machine-readable medium 1022 is shown in an example embodiment to be a single medium, the term “machine-readable medium” should be taken to include a single medium or multiple media (e.g., a centralized or distributed database, and/or associated caches) that store the one or more sets of instructions. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the invention(s) is (are) described with reference to various implementations and exploitations, it will be understood that these embodiments are illustrative and that the scope of the invention(s) is not limited to them. In general, techniques for mouse navigation may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computer mouse adapted for operation on a support surface, the computer mouse comprising:
a surface tracking sensor configured to detect a first movement of the computer mouse along the support surface;
at least one orientation sensor configured to detect a second movement of the computer mouse relative to a pivot point; and
a controller in communication with the surface tracking sensor and the at least one orientation sensor, the controller being configured to translate the first movement into a two-dimensional coordinate and to translate the second movement into a magnitude of rotation.

2. The computer mouse of claim 1, wherein the controller is further configured to translate the magnitude of rotation into a scroll event and to transmit the two-dimensional coordinate and the scroll event to a processing system in communication with the computer mouse.

3. The computer mouse of claim 1, wherein the controller is further configured to translate the magnitude of rotation into a yaw event and to transmit the two-dimensional coordinate and the yaw event to a processing system in communication with the computer mouse.

4. The computer mouse of claim 1, wherein the second movement is at least one of a yaw, a pitch or a roll of the computer mouse relative to the support surface.

5. The computer mouse of claim 1, wherein the orientation sensor comprises a gyroscope.

6. The computer mouse of claim 1, wherein the orientation sensor comprises an accelerometer.

7. A computer mouse adapted for operation on a support surface, the computer mouse comprising:
an optical sensor configured to detect features of the support surface;
at least one gyroscope configured to detect a roll of the computer mouse; and
a controller in communication with the optical sensor and the at least one gyroscope, the controller configured to identify movement of the computer mouse along the support surface based on the features and to identify a magnitude of the roll of the computer mouse.

8. The computer mouse of claim 7, wherein the controller is configured to calibrate the at least one gyroscope in reference to at least one of the features of the support surface.

9. The computer mouse of claim 8, wherein the controller is configured to identify a quality of the support surface from the at least one of the features and to calibrate the at least one gyroscope in reference to the quality of the support surface.

10. The computer mouse of claim 7, wherein the optical sensor comprises a light-emitting diode.

11. The computer mouse of claim 7, wherein the controller is further configured to transmit a control signal to a processing system identifying the magnitude of the roll.

12. The computer mouse of claim 7, wherein the at least one gyroscope is configured to detect a pitch of the computer mouse.

13. The computer mouse of claim 7, wherein the at least one gyroscope is configured to detect a yaw of the computer mouse.

14. The computer mouse of claim 7, further comprising an accelerometer in communication with the controller, the accelerometer configured to detect a direction of gravity, and wherein the controller is further configured to calibrate the at least one gyroscope in reference to the direction of the gravity.

15. The computer mouse of claim 14, wherein the accelerometer is configured to detect an acceleration of the computer mouse along a direction parallel to the support surface, and wherein the controller is further configured to calibrate the at least one gyroscope in reference to the detected acceleration.

16. The computer mouse of claim 7, wherein the computer mouse comprises a bottom surface having a convex shape, the bottom surface configured to contact the support surface.

17. A method of processing input signals in a computer mouse comprising a surface tracking sensor configured to detect a movement of the computer mouse along a support surface and at least one orientation sensor configured to detect a rotational movement relative to the support surface, the method comprising the acts of:
detecting the movement of the computer mouse along the support surface through use of the surface tracking sensor;
detecting the rotational movement of the computer mouse though use of the at least one orientation sensor;
translating the rotational movement into a magnitude of rotation; and
transmitting the movement of the computer mouse along the support surface and the magnitude of rotation to a processing system in communication with the computer mouse.

18. The method of claim 17, wherein the rotational movement is a roll, the method further comprising the acts of:
translating the roll into a scroll event along a horizontal direction based on the magnitude of rotation; and
transmitting the scroll event along the horizontal direction to the processing system.

19. The method of claim 17, wherein the rotational movement is a pitch, the method further comprising the acts of:
translating the pitch into a scroll event along a vertical direction based on the magnitude of rotation; and
transmitting the scroll event along the vertical direction to the processing system.

20. The method of claim 17, wherein the rotational movement is a yaw, the method further comprising the acts of:
translating the yaw into a yaw event based on the magnitude of rotation; and
transmitting the yaw event to the processing system.

21. A machine-readable medium that stores instructions, which when performed by a computer mouse having a surface tracking sensor configured to detect a movement of the computer mouse along a support surface and at least one orientation sensor configured to detect a roll of the computer mouse relative to the support surface, cause the computer mouse to perform operations comprising:
detecting the movement of the computer mouse along the support surface through use of the surface tracking sensor;
detecting the roll of the computer mouse through use of the at least one orientation sensor;
translating the roll into a scroll event along a horizontal direction; and
transmitting the movement of the computer mouse along the support surface and the scroll event to a processing system in communication with the computer mouse.

22. The machine-readable medium of claim 21, wherein the at least one orientation sensor is further configured to detect a pitch of the computer mouse relative to the support surface and wherein the instructions, when performed by the computer mouse, cause the computer mouse to perform operations further comprising:
detecting the pitch of the computer mouse through use of the at least one orientation sensor;
translating the pitch into a scroll event along a vertical direction; and
transmitting the scroll event along the vertical direction to the processing system.

23. The machine-readable medium of claim 21, wherein the at least one orientation sensor is further configured to detect a yaw of the computer mouse relative to the support surface and wherein the instructions, when performed by the computer mouse, cause the computer mouse to perform operations further comprising:
detecting the yaw of the computer mouse through use of the at least one orientation sensor;
translating the yaw into a yaw event; and
transmitting the yaw event to the processing system.

24. A method of moving displayed content with a computer mouse, the method comprising the acts of:
receiving a control signal from the computer mouse that identifies a movement of the computer mouse relative to a pivot point; and
translating the movement of the computer mouse into a scroll event, the scroll event configured to scroll the displayed content.

25. The method of claim 24, wherein the control signal further identifies a further movement of the computer mouse relative to a pivot point, the method further comprising translating the further movement of the computer mouse into a yaw event, the yaw event configured to rotate the displayed content.

26. The method of claim 24, wherein the movement is a roll and the scroll event is configured to scroll the displayed content along a horizontal direction.

27. The method of claim 24, wherein the movement is a pitch and the scroll event is configured to scroll the displayed content along a vertical direction.
